(19) United States
(12) Patent Application Publication
(10) Pub. No.: US 2006/0212166 A1
(43) Pub. Date: Sep. 21, 2006

(54) Process analysis system

(75) Inventors: Donald Cowling, Dorset (GB); Darren Stinchcombe, Dorset (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED, London (GB)

(21) Appl. No.: 10/552,338

(22) PCT Filed: Apr. 6, 2004
(86) PCT No.: PCT/GB04/01510

§ 371 Date: Oct. 7, 2005

(30) Foreign Application Priority Data
Apr. 12, 2003 (GB) 0308468.8

(51) Int. Cl. G06F 17/00

(52) U.S. Cl. 700/225

(57) ABSTRACT

A process analysis system for analyzing the efficiency of industrial processes includes a first radio system (104) associated with an input part of a processing system, and a second radio system (105) associated with an output part of a processing system, and a Radio Frequency Identification (RFID) tag associated with an item (103) to be processed, wherein the first and second radio systems are able to communicate with the RFID tag as it and its associated item pass through the processing system, and data associated therewith is stored on a data logging system. The system may be employed to check the time taken to process the item, or to check other parameters of the process, such as sorting accuracy for a sorting process. The system is particularly suited to use in waste product sorting and filtration systems, where RFID tags can be placed on a sample basis on items to be sorted, but may be applied to other suitable processes.

This invention relates to the analysis of the efficiency of industrial processes, particularly but not exclusively in the field of waste product sorting.

The task of sorting a quantity of different objects into defined groups is one that is commonplace in industrial environments. The degree of difficulty encountered in the sorting process is very dependent upon the type of object to be sorted. Regular shaped objects, such as coins for example, can be sorted into different types relatively easily by existing machinery, and the efficiency of the process, as measured by the relative numbers of incorrectly sorted items, can be detected by means such as automated observation of the sorted output using cameras and digital image processing systems. Irregularly shaped objects, such as the contents from household waste bins, are much more difficult to sort in as efficient a manner, as it one cannot guarantee from one bin to the next what the contents will be, and in what condition those contents are in. Observation of the contents cannot be easily done as there are so many types of product that may come through the system, and the products—bottles, cans and cartons etc—may be damaged and deformed away from any regular shape.

However, sorting machinery has been developed that is able to cope with such waste. See for example the products of MSS Inc. 3738 Keystone Av. Nashville, Tenn. 37211 U.S.A, (see also http://www.magsep.com/) which are industrial waste product sorting machines as typically operated in a Material Reclamation Facility (MRF).

MRFs perform the tasks of identifying, separating and recycling various types of waste, whether domestic or industrial. Many processes within a MRF are automated and typically a waste stream comprising mixed waste may travel along a manual sorting conveyor. This splits the waste stream into several different streams, each processing one sort of waste. Mixed waste travelling along the manual sorting conveyor is subject to a number of analyses to identify the constituents of the waste and, therefore, determine how to sort it.

The efficiency of the sorting process, both in terms of speed of operation, and percentage of incorrectly sorted items is important information for the operators of the MRF to know. Data relating to these factors can be used to target improvements to the MRF equipment and operation. Ideally, information on the performance of individual machines and sub-processes used within the MRF should be obtained.

An existing method of generating efficiency data involves a process engineer examining the contents of the output from a given sorting process, counting items that have been mis-sorted and comparing this against correctly sorted items from the same output, so that the percentage error in the process can be calculated. This is a time consuming, messy and dangerous task, and so cannot easily be done very often. Changes in efficiency, due to machine malfunction etc, can therefore be easily missed. Further, the method does not provide information on the rate of processing the material.

Rate of processing can be calculated roughly by examining how quickly a given input of waste product takes to enter the sorting process. However, without reliable information on the quality of the sorting process, the information is of limited value.

According to the present invention there is provided a process analysis system characterised in that it-comprises a first radio system associated with an input part of a processing system, and a second radio system associated with an output part of the processing system, and a Radio Frequency Identification (RFID) tag associated with an item to be processed, and data logging means in communication with the first and second radio systems, wherein the first and second radio systems are arranged to communicate with the RFID tag as it passes through the processing system and to pass data associated therewith to the data logging means, so as to record parameters associated with the processing system.

Note that the output part of the processing system may be an output of one part of the processing system, or may be the final output of the processing system.

A system according to the present invention provides the advantage that useful information is generated relating to the efficacy of the processing system without requiring every item that passes through the processing system to be associated with a tag. Furthermore, in operation the analysis system need not be in communication with the processing system itself. However, data from the analysis system may be used to control elements of the processing system if, for example, it is found that the processing system is deficient in some manner.

RFID tags are conveniently employed as described herein as they can be small and non-intrusive, and so will have minimal impact on the operation of the processing system. RFID tags can also be made very cheaply, and so can be regarded as disposable items, eliminating any need to recover them once they have passed through the sorting process. Thus, the use of RFID tags is particularly suitable for application to the study of the sorting of waste products.

The RFID tag is preferably a passive tag. These tags have no internal power source of their own, and they operate by extracting power from RF energy impinging upon the tag, and transmit their own signal using this captured energy. This signal transmitted may be, in the simplest case, the RF signal used to energise it, but modified in some fixed manner. For example, the tag may have a detector and radiating antenna which radiates a signal at double the frequency of the energising signal. Such tags may be used to identify its presence or otherwise, but has the disadvantage that individual tags cannot be discriminated from each other. More advanced tags are able to modulate the received signal in a variable manner, which variations may, for example, comprise of an identity code. These tags are slightly more expensive than the simplest tags, but are much more versatile, as they can be used to identify themselves uniquely in the presence of other tags. Preferably the tag used with the current invention is this latter type of tag.

The tag may advantageously be able to store data supplied by the energising field. These tags are known as read/write tags. This allows versatility in that data pertaining to the processing conditions extant at a given time may be transferred to the tag. For example, during passage through a processing operation, status information relating to the processing system could be stored on the tag at the input stage and read from it at the output stage. For further information on RFID tagging systems, see the web site www.rfid.org. Each radio system may comprise a radio receive channel arranged to receive signals transmitted at a frequency as transmitted by the RFID tag., Each radio system may further incorporate a transmit sub-system able to provide an RF energising field suitable for energising the RFID tag. Alternatively or as well, a separate transmitter may be used to supply the RF energising field. The transmit sub-system or separate transmitter may be adapted to write information to a suitable RFID tag. Note that the radio systems may share some elements of their architecture. In particular, the “back end” processing elements that are used to process the baseband data may be common to both or all receivers.

The sensitivity of the radio system receivers and RF power transmitted by the tag are preferably chosen such that a signal produced by the tag can only be received by a single receiver at any one time. More preferably these parameters are chosen such that the tag will be detected by a radio system when the tag is within a known range of the receive system's antenna. This will, prevent confusion caused by a receiver falsely detecting the presence of a tag, and also give some certainty about the approximate location of the tagged item.

The analysis system is preferably arranged to record a time event associated with the communication with the RFID tag. The time event record may be generated by the radio system and passed to the datalogger, which may store the event, along with any identity code associated with the tag. Alternatively, the datalogger may generate the time event by recording the time at which it receives a communication from the radio system. In this way, when a tag has passed from an input of the processing system to an output and read by the first and second radio systems, the time taken for the tag, and hence the article to which it is attached, to pass through the process can be calculated.

Where process systems have multiple outputs, such as in a sorting process, a radio system is preferably located at each output. A tagged article passing through the process can then be tracked to see if it emerges at the correct output.

The data logger is preferably a computer system. The computer system may obtain data from the radio system via a cable system or via an additional radio link, or by any other suitable means. The data logger may be adapted to compute statistics relating to the efficiency of the process, for example the speed of processing and percentage of processing errors may readily be computed, and given knowledge of the percentage of items to be processed to which tags have been attached, the overall quantities of items processed may be estimated.

According to a further aspect of the invention there is provided a method of analysing a processing system characterised in that it comprises the steps of:

attaching to an item to be processed a Radio Frequency Identification (RFID) tag;

reading information from the RFID tag using a first radio system as the item is passed into the processing system;

reading information from the RFID tag using a second radio system as the item is passed out from the processing system;

passing information relating to the tag from the first and second radio systems to data logging means.

The invention will now be described in more detail, by way of example only, with reference to the following figures, of which:

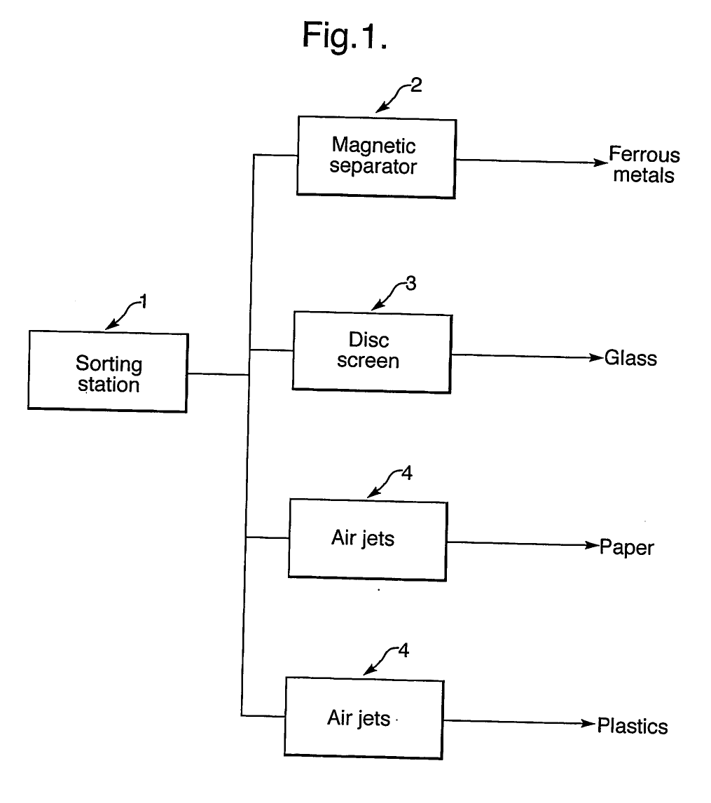

FIG. 1 (prior art) shows in block diagrammatic form the requirements of an MRF sorting facility.

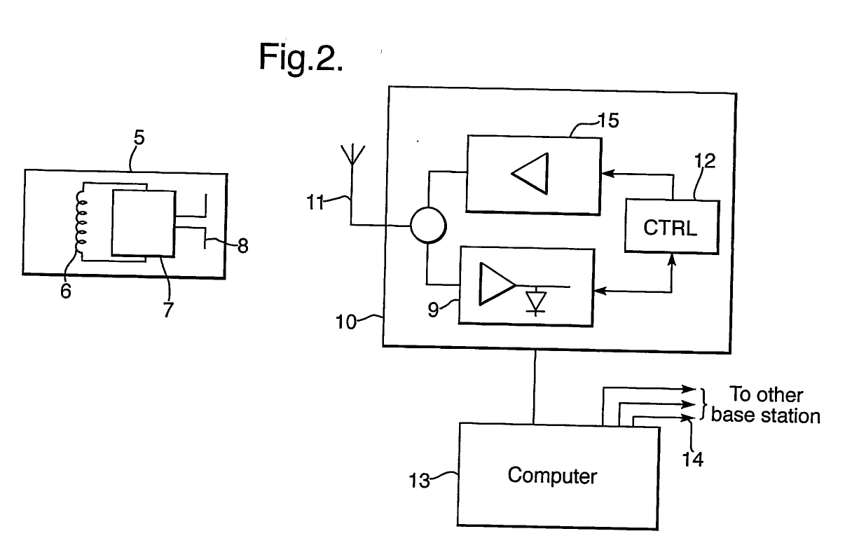

FIG. 2 (prior art) shows in block diagrammatic form the operation of an RFID tagging system.

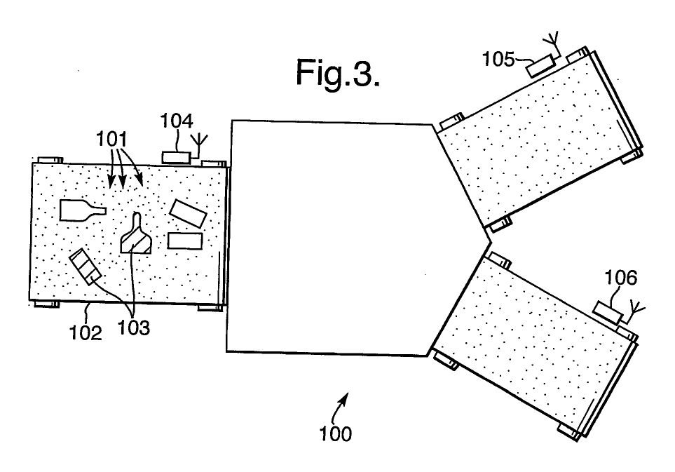

FIG. 3 shows in block diagrammatic form the current invention being applied to a sorting process.

Illustrated in FIG. 1 is a block diagram showing a typical (simplified) process that is undergone when sorting waste products at a facility such as an MRF. Waste matter arriving at the facility is input to the sorting station 1. The matter is then separated into basic categories using known techniques. A magnetic separator 2 is used to remove ferrous metals from the waste matter. The ferrous metals are then processed appropriately. Glass products are separated by means of a disc screen 3, and then processed, whereas jets of air 4 are used to filter paper, cardboard and plastics, and to further categorise these once separated.

These sorters and filters are not perfect, and materials can easily end up in the wrong category. Also, items that comprise two or more different materials cannot be correctly sorted into a single material output, and so will need further separation to achieve good results. Thus, errors in sorting are common. Measurement of these errors is the purpose of the current invention.

FIG. 2 shows a block diagram of the operation of one form of an RFID tagging system. A tag 5 comprises of a power transducer 6, a modulator 7 and an antenna 8. The transducer 6 converts received RF energy into a form that can be used by the modulator 7. On receipt of RF energy from a transmitter 15 within a base station 10, the transducer 6 will power up the modulator 7, which will transmit a modulated form of the RF energy via its antenna 8. The energy will be received by a receive module 9 via antenna system 11 of the base station 10, which will demodulate the signal and pass data extracted to a control module 12. This will in turn pass the data to a computer system 13 where it may be recorded or further processed. Other base stations may be present, and be connected to the computer system 13 via connections 14.

FIG. 3 shows the application of an RFID system to a processing system as per the current invention. A processor, such as a sorting machine 100 is supplied with material 101 via a conveyor 102. An operator will attach an RFID tag to several items 103 on the conveyor, or alternatively may introduce additional items which have had RFID tags already applied to them, and will record the identity of the RFID tag attached to each item onto a computer system (not shown). These items then pass into the sorting machine 100 after having their identity codes within the RFID tags read by a first radio system 104. The first radio system 104 passes the identity code to the computer system, where it and its time of arrival are stored.

On output from the sorting system 100 the items will pass either a second radio system 105 or a third radio system 106. The radio systems 105, 106 will read the identity codes of the tagged items 103, and pass this information to the computer system. The computer system again records the identity code and time of arrival, and additionally records which radio system 105, 106 received the code from which tag.

The computer system now has all the information required to calculate the time taken for the items to pass from the input to an output. Given knowledge of which tag was applied to which item, the computer can also detect errors in the sorting process, i.e. which items have been incorrectly classified by the sorter. With the knowledge of the number of items that have been tagged and passed through the system, the efficiency of the sorting process can be determined. The proportion of tagged items 103 to untagged items should be chosen such that the results are statistically significant, bearing in mind the normal throughput of the sorting machine 100.

In a further embodiment, the first radio system 104 is arranged to write information to the tagged items 103 relating to the process being measured. This information can be read by radio systems 105 or 106 as appropriate, and stored along with identity code information as before. In this way, further information can be annotated to the data supplied to the computer system which can be used as a check against procedural errors being made in the collation of the data.

The skilled person will be aware that other embodiments within the scope of the invention may be envisaged, and thus the invention should not be limited to the embodiments as herein described.

1. A process analysis system characterised in that it comprises a first radio system associated with an input part of a processing system, and a second radio system associated with an output part of the processing system, and a Radio Frequency Identification (RFID) tag associated with an item to be processed, and data logging means in communication with the first and second radio systems, wherein the first and second radio systems are arranged to communicate with the RFID tag as it passes through the processing system and to pass data associated therewith to the data logging means, so as to record parameters associated with the processing system.

2. A process analysis system as claimed in claim 1 wherein the RFID tag is applied to an item to be passed through a waste product sorting facility.

3. A process analysis system as claimed in claim 1 wherein the RFID tag does not contain an internal power source, and is arranged, on interrogation from either the first or second radio systems, to transmit an identity code.

4. A process analysis system as claimed in claims 1 wherein the data logging means is arranged to record information relating to the time interval taken for the RFID tag to pass from the first radio system to the second radio system.

5. A process analysis system as claimed in claim 1 wherein a third radio system is associated with a second output of the processing system, and the data logging means is arranged to record at which output the RFID tag arrives after passing through the processing means.

6. A process analysis system as claimed in claim 1 wherein the data logging means comprises a computer system.

7. A process analysis system as claimed in claim 1 wherein the RFID tag is able to store information written to it using a radio frequency field.

8. A process analysis system as claimed in claim 7 wherein a transmitter is arranged to write data to the RFID tag as it passes through the processing system.

9. A process analysis system as claimed in claim 1 wherein the data logging means is arranged to calculate statistics pertaining to the processing system based upon parameters provided relating to the quantity and percentage of items associated with a tag and the data measured using the radio systems.

10. A method of analysing a processing system characterised in that it comprises the steps of:
attaching to an item to be processed a Radio Frequency Identification (RFID) tag;
reading information from the RFID tag using a first radio system associated with an input to the processing system as the item is passed into the input;
reading information from the RFID tag using a second radio system associated with an output of the processing system as the item is passed from the output;
passing information relating to the tag from the first and second radio systems to data logging means.

11. A method as claimed in claim 10 wherein the RFID tag is applied to an item to be passed through a waste product sorting facility.

12. A method as claimed in claim 10 wherein the data logging means records information relating to the time interval taken for the RFID tag to pass from the first radio system to the second radio system.

13. A method as claimed in claim 10 wherein a third radio system is associated with a second output of the processing system, and the data logging means records at which output the RFID tag arrives after passing through the processing means.
